(19) United States
(12) Patent Application Publication
(10) Pub. No.: US 2015/0042908 A1
(43) Pub. Date: Feb. 12, 2015

(54) TOUCH PANEL AND TOUCH DISPLAY APPARATUS

(71) Applicants: Wen-Chun Wang, Taichung City (TW); Ting-Yu Chang, Kaohsiung County (TW); Ching-Fu Hsu, Taichung City (TW); Ying-Ching Tseng, Taichung City (TW)

(72) Inventors: Wen-Chun Wang, Taichung City (TW); Ting-Yu Chang, Kaohsiung County (TW); Ching-Fu Hsu, Taichung City (TW); Ying-Ching Tseng, Taichung City (TW)

(73) Assignee: WINTEK CORPORATION, Taichung City (TW)

(21) Appl. No.: 14/454,731

(22) Filed: Aug. 8, 2014

(30) Foreign Application Priority Data
Aug. 8, 2013 (TW) 102128514

(51) Int. Cl. G06F 3/041

(52) U.S. Cl. CPC G06F 3/041
USPC 349/12

(57) ABSTRACT

A touch panel, including a substrate, a first electrode structure, a second electrode structure, and an insulating layer. The first electrode structure includes first electrode units and second electrode units, wherein each first electrode unit extends in a first direction, each second electrode unit extends in a second direction, and the first electrode units interlace the second electrode units. The first electrode structure is configured between the second electrode structure and the substrate. The insulating layer is configured between the first electrode structure and the second electrode structure to electrically insulate the first electrode structure from the second electrode structure. In a first touch mode, the second electrode structure does not perform a touch sensing function, while the first electrode units and the second electrode units are electrically independent respectively and perform the touch sensing function. In a second touch mode, the second electrode structure performs the touch sensing function.

### CROSS-REFERENCE TO RELATED APPLICATION

This application claims the priority benefit of Taiwan application serial no. 102128514, filed on Aug. 8, 2013. The entirety of the above-mentioned patent application is hereby incorporated by reference herein and made a part of this specification.

### BACKGROUND OF THE INVENTION

1. Field of the Invention

The invention relates to an electronic apparatus, and more particularly to a touch panel and a touch display apparatus.

2. Description of Related Art

In recent years, due to the convenience and intuitiveness on controlling, touch electronic products are favored by consumers and have become the mainstream in the market. Currently, the most commonly adopted touch sensing principles can be roughly categorized into resistive type, capacitive type, infrared sensing type, electromagnetic sensing type, and sound wave sensing type. Since a capacitive type touch panel is more advantageous in terms of transparency, hardness, accuracy, reflecting time, and lifetime, an electronic apparatus that integrates the capacitive touch panel and a display is mostly adopted currently. Moreover, along with the increasing number of functions in the electronic products, the operating method that requires physical touch on the apparatus can no longer satisfy the demands from users; therefore, hovering touch sensing electronic products have been further developed in recent years, so as to enhance the convenience and intuitiveness on operating for users. Moreover, along with the demand for an electronic apparatus that has the advantages of light, with high touch sending resolution and maximized effective display area, it has become an urgent issue for manufacturers of touch electronic products to configure the areas providing sensing functions such as a hovering touch sensing or physical touch sensing in a non-display area without affecting the aforementioned requirement.

### SUMMARY OF THE INVENTION

Accordingly, the invention is to provide a touch panel and a display apparatus thereof which have a touch sensing function in both non-display area and display area and meet the requirement for a maximized effective display area. In addition, the invention may further provide a touch panel and a display apparatus having both contact touch function and hovering touch function.

A touch panel according to an embodiment of the invention includes a substrate, a first electrode structure, a second electrode structure, and an insulating layer. The substrate includes an operating area and the first electrode structure is located within the operating area. The first electrode structure includes a plurality of first electrode units and a plurality of second electrode units, wherein each of the first electrode units extends in a first direction, each of the second electrode units extends in a second direction, and the first electrode units and the second electrode units interlace with each other. The second electrode structure is distributed evenly in the operating area, and the first electrode structure is disposed between the second electrode structure and the substrate. The insulating layer is disposed between the first electrode structure and the second electrode structure to electrically insulate the first electrode structure from the second electrode structure. In a first touch mode, the second electrode structure does not perform a touch sensing function, and the first electrode units and the second electrode units are electrically independent from each other respectively and perform the touch sensing function. In a second touch mode, the second electrode structure performs the touch sensing function.

In an embodiment of the invention, an n^{th} first electrode unit, an m^{th} first electrode unit, an j^{th} second electrode unit, and a j^{th} second electrode unit of the first electrode structure are electrically independent from one another in the second touch mode to constitute a plurality of axial sensing electrodes. Meanwhile, the first electrode unit between the n^{th} and the m^{th} first electrode units as well as the second electrode unit between the i^{th} and the j^{th} second electrode units are electrically connected to each other in the second touch mode to constitute a plane sensing electrode. Here, n, m, i, and j are positive integers greater than zero; the difference between n and m is greater than two, and the difference between i and j is greater than two.

In an embodiment of the invention, the second electrode structure is a driving electrode in the second touch mode.

In an embodiment of the invention, the second electrode structure is connected to a ground potential or a common potential in the first touch mode.

In an embodiment of the invention, the touch panel further includes a third electrode structure. The third electrode structure is disposed on the substrate and located between the first electrode structure and the substrate. The third electrode structure includes a plurality of axial sensing electrodes surrounding a periphery of the operating area. The third electrode structure performs the touch sensing function in the second touch mode. The first electrode units and the second electrode units of the first electrode structure are electrically connected to each other in the second touch mode to constitute a plane sensing electrode. Alternatively, the touch panel may further include a fourth electrode structure, and the fourth electrode structure is distributed within the operating area along a gap between the first electrode units and the second electrode units so as to constitute a plane sensing electrode in the second touch mode. Meanwhile, the touch panel further includes a plurality of insulating structures disposed in a position where the fourth electrode structure, the first electrode units, and the second electrode units interlace with one another.

In an embodiment of the invention, the second electrode structure is disposed on a carrier layer, and the carrier layer is adhered to the substrate via an optical adhesive. The second electrode structure may be located between the carrier layer and the optical adhesive.

In an embodiment of the invention, the first electrode structure is disposed on a carrier layer, and the carrier layer is adhered to the substrate via an optical adhesive so that the first electrode structure is located between the carrier layer and the substrate.

In an embodiment of the invention, in the first touch mode, the first electrode units are sensing electrodes and the second electrode units are driving electrodes; alternatively, the first electrode units are driving electrodes and the second electrode units are sensing electrodes.

In an embodiment of the invention, each of the first electrode units and each of the second electrode units are electrode series including a plurality sensing electrodes and connecting electrodes that connect the sensing electrodes in series. The sensing electrodes and connecting electrodes in at least one electrode series are made of the same material. Alternatively, the sensing electrodes and the connecting electrodes in at least one electrode series are made of different material.

In the invention, a touch panel includes a substrate, a first electrode structure, a second electrode structure, and an insulating layer. The substrate has an operating area. The first electrode structure is located within the operating area. The second electrode structure is disposed between the first electrode structure and the substrate and includes a plurality of axial sensing electrodes. In a first touch mode, the second electrode structure does not perform a touch sensing function, and the first electrode structure performs the touch sensing function; in a second touch mode, the second electrode structure performs the touch sensing function, and the first electrode structure does not perform the touch sensing function. The insulating layer is disposed between the first electrode structure and the second electrode structure to insulate the first electrode structure from the second electrode structure.

In an embodiment of the invention, the axial sensing electrodes of the second electrode structure are located within a periphery area outside the operating area.

In an embodiment of the invention, the axial sensing electrodes of the second electrode structure include a first axial sensing electrode and a second axial sensing electrode; the first axial sensing electrode and the second axial sensing electrode are respectively located at two opposite sides of the operating area. The axial sensing electrodes of the second electrode structure further include a third axial sensing electrode and a fourth axial sensing electrode. The first axial sensing electrode, the second axial sensing electrode, the third axial sensing electrode, and the fourth axial sensing electrode surround the operating area. The third axial sensing electrode and the fourth axial sensing electrode are respectively located at the other two opposite sides of the operating area.

The invention provides another touch panel having a light-penetrable area and a light-shielding area, wherein the light-shielding area is located at least one side of the light-penetrable area. The touch panel includes a first substrate, a second substrate, a decoration layer, a first electrode structure, and a second electrode structure. The second substrate and the first substrate are disposed substantially in parallel. The decoration layer is disposed on the second substrate to form the light-shielding area. The first electrode structure is configured on the first substrate and at least disposed in the light-penetrable area, wherein the first electrode structure includes a plurality of sensing electrodes and a plurality of wirings. The wirings and the sensing electrodes are electrically connected. The second electrode structure is at least disposed on the decoration layer. The second electrode structure is located between the first electrode structure and the second substrate. The second electrode structure and the first electrode structure are electrically independent from each other; the second electrode structure includes a plurality of additional sensing electrodes and a plurality of axial sensing electrodes.

In an embodiment of the invention, a portion of the wirings overlaps with a portion of the additional sensing electrodes. In addition, a shielding layer is disposed between the first electrode structure and the second electrode structure so as to block mutual interference between the first electrode structure and the second electrode structure.

Based on the above, the invention may provide a touch panel and a display apparatus thereof having a touch sensing function in both non-display area and display area, which can further meet the requirement for a maximized effective display area. Additionally, with the touch panel in the embodiments of the invention having at least two electrode structures, a first electrode structure is utilized to realize a physical touch function, and both the first electrode structure and the second electrode structure are utilized to realize a hovering touch function; alternatively, only the operation of the second electrode structure is utilized to realize the hovering touch function. Moreover, the touch panel in the embodiments of the invention may be provided with an additional third electrode structure so that the operation of the first, second, and third electrode structures can be utilized to realize the hovering touch function. Alternatively, the touch panel in the embodiments of the invention may be provided with additional third and fourth electrode structures so that the operation of the second, third, and fourth electrode structures can be utilized to realize the hovering touch function. Meanwhile, the touch display apparatus in the embodiments of the invention provides at least two touch sensing modes so as to realize the physical touch function and the hovering touch function.

In order to make the aforementioned features and advantages of the invention more comprehensible, embodiments accompanying figures are described in detail below.

### BRIEF DESCRIPTION OF THE DRAWINGS

FIG. 1 is a cross-sectional view illustrating a touch panel in a first embodiment of the invention.

FIG. 2 is a top view illustrating a first electrode structure in the touch panel in FIG. 1.

FIG. 3 is a top view illustrating a second electrode structures in the touch panel in FIG. 1.

FIG. 4 is a schematic view illustrating a first touch display apparatus having the touch panel in the first embodiment of the invention.

FIG. 5 is a schematic view illustrating a second touch display apparatus having the touch panel in the first embodiment of the invention.

FIG. 6 is a schematic view illustrating a third touch display apparatus having the touch panel in the first embodiment of the invention.

FIG. 7 is a schematic view illustrating a fourth touch display apparatus having the touch panel in the first embodiment of the invention.

FIG. 8 is a cross-sectional view illustrating a touch panel in a second embodiment of the invention.

FIG. 9 is a schematic view illustrating a first electrode structure, a second electrode structure, and a third electrode structure in the touch panel in FIG. 8.

FIG. 10 is a schematic view illustrating a first touch display apparatus having the touch panel in the second embodiment of the invention.

FIG. 11 is a schematic view illustrating a second touch display apparatus having the touch panel in the second embodiment of the invention.

FIG. 12 is a schematic view illustrating a third touch display apparatus having the touch panel in the second embodiment of the invention.

FIG. 13 is a cross-sectional view illustrating a touch panel in a third embodiment of the invention.

FIG. 14 is a top view illustrating a first sensing electrode layer and a second sensing electrode layer in the touch panel in FIG. 13.

FIG. 15A is a bottom view illustrating a touch panel in a fourth embodiment of the invention.

FIGS. 15B-15G illustrate a plurality of designs for an additional sensing electrode.

FIG. 16 is a cross-sectional view of the touch panel in FIG. 15A along line II-II′.

FIG. 17 is a bottom view illustrating a touch panel in a fifth embodiment of the invention.

FIG. 18 is a cross-sectional view illustrating the touch panel in FIG. 17 along line III-III′.

### DESCRIPTION OF EMBODIMENTS

### First Embodiment

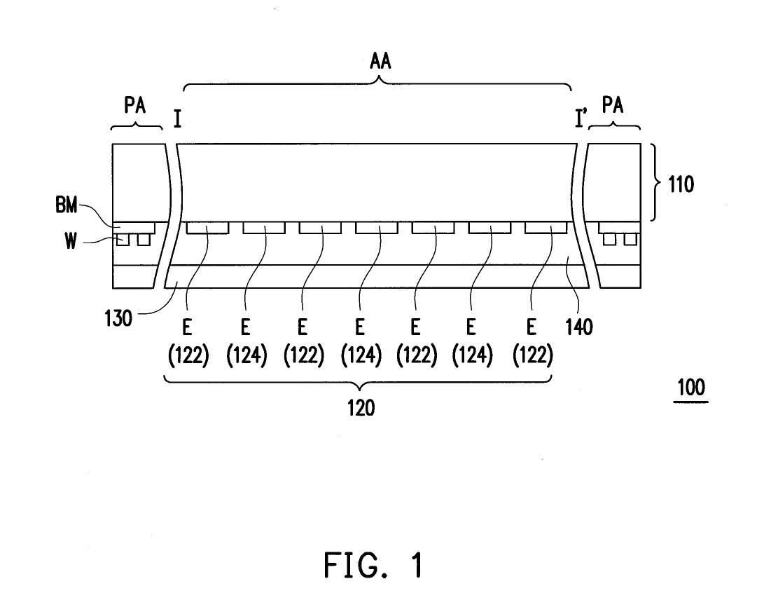

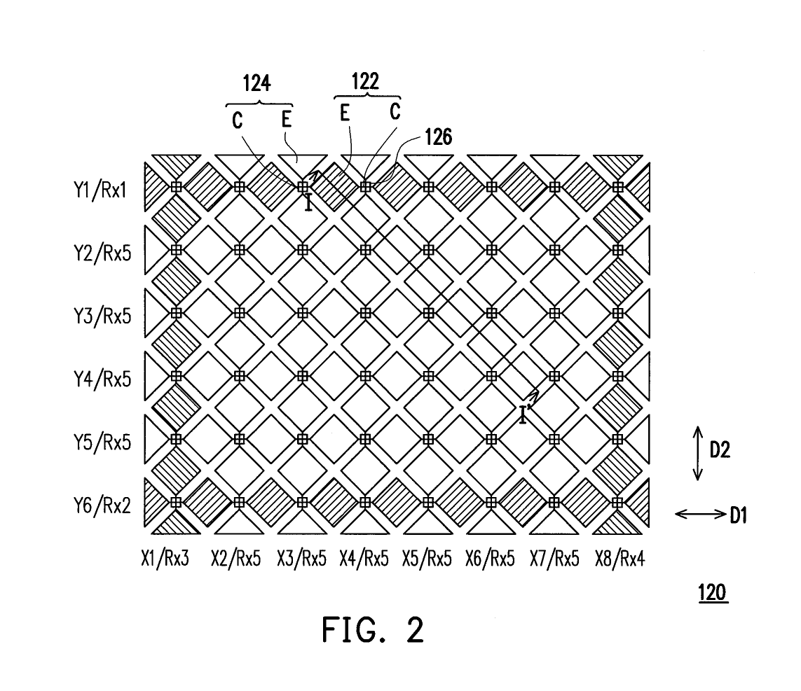

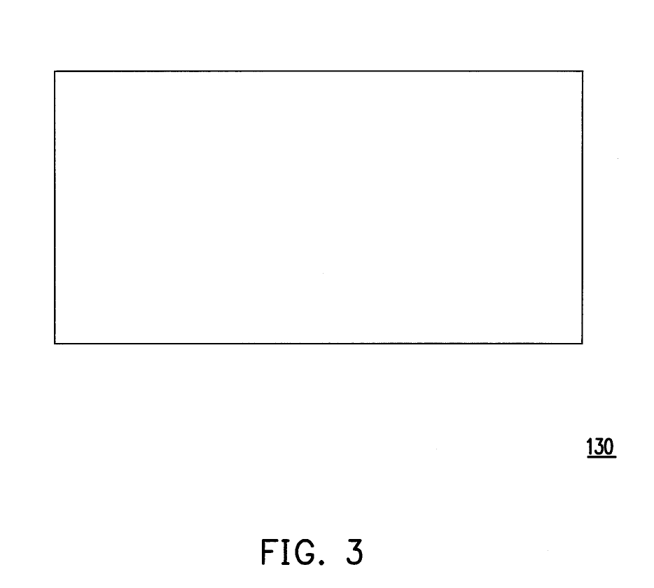

FIG. 1 is a cross-sectional view illustrating a touch panel in a first embodiment of the invention. FIG. 2 is a top view illustrating a first electrode structure in the touch panel in FIG. 1. FIG. 3 is a top view illustrating a second electrode structure in the touch panel in FIG. 1. Please refer to FIGS. 1-3. A touch panel 100 includes a substrate 110, a first electrode structure 120, a second electrode structure 130, and an insulating layer 140. The substrate 110 has an operating area AA and a periphery area PA. Generally speaking, the operating area AA is provided for a user to perform a touch sensing function and is surrounded by the periphery area PA. In practical applications, the touch panel 100 may be disposed on the top of the display panel to constitute a touch display apparatus. In general, the periphery area PA of the substrate 110 is provided with a decoration layer BM, and wirings W, wherein the decoration layer BM is located between the wirings W and the substrate 110 so as to shield the wirings W, thereby constituting a light-shielding area in the touch panel 100. Moreover, for the touch panel 100 integrated with the display, an area without the decoration layer BM is a light-penetrable area. The substrate 110 may be provided for the user to perform touch operation, which may be a reinforced glass substrate, a reinforced plastic substrate, a hard glass substrate, a flexible glass substrate, a hard plastic substrate, a flexible plastic substrate, or a cover lens. Furthermore, the decoration layer BM may be an insulating material formed of one or multiple of the materials including ceramics, a color ink, a photoresist, a diamond-like carbon, or a resin.

The first electrode structure 120 is mostly located within the operating area AA and may be electrically connected to the wirings W. Meanwhile, the wirings W transmit a touch sensing signal or a scanning signal. Here, the operating area AA is an area physically touched by the user when performing the touch operation. In other embodiments, the periphery area PA may selectively be provided with a sensing component, and therefore may be an area physically touched by the user when performing the touch operation. However, the periphery area PA is an opaque area provided with the decoration layer BM. Also, when the touch panel 100 collocates with the display panel to constitute the touch display apparatus, the operating area AA having the light-penetrable effect may serve as a display area for displaying an image. FIG. 2 shows that the first electrode structure 120 includes a plurality of first electrode units 122 and a plurality of second electrode units 124, wherein each of the first electrode units 122 extends in a first direction D1, and each of the second electrode units 124 extends in a second direction D2; the first electrode units 122 and the second electrode units 124 interlace with each other. A plurality of first electrode units 122 and a plurality of second electrode units 124 may be respectively connected to a wiring W. In some embodiment, the first electrode structure 120 disposed within the operating area AA can be extended to the periphery area PA for enhancing the touch sensitive between the operating area AA and the periphery area PA.

More specifically, in the embodiment, each of the first electrode units 122 and each of the second electrode units 124 are electrode series, and each electrode series includes a plurality of electrode patterns E and connecting patterns C that connect the electrode patterns E in series. When the first electrode units 122 and the second electrode units 124 are realized with the electrode series structure, the electrode patterns E and the connecting patterns C in at least one electrode series may have the same material, such as metal or indium tin oxide. In addition, the electrode patterns E and the connecting patterns C may also be formed of a metal mesh. Alternatively, the electrode patterns E and the connecting patterns C in at least one electrode series have different material. Besides, an insulating structure 126 may be provided at a position where the first electrode units 122 and the second electrode units 124 interlace with each other at the connecting patterns C to separate the first electrode units 122 from the second electrode units 124. It should be noted that, in the cross-sectional structure in FIG. 1, the cross-section of the operating area AA corresponds to line I-I′ in FIG. 2. Therefore, FIG. 1 only shows the cross-sectional structure of the electrode patterns E.

The second electrode structure 130 in the embodiment is distributed evenly in the operating area AA, and the first electrode structure 120 is disposed between the second electrode structure 130 and the substrate 110. Thus, to keep the first electrode structure 120 being electrically independent from the second electrode structure 130, the insulating layer 140 is disposed between the first electrode structure 120 and the second electrode structure 130, wherein the insulating layer 140 may be a protecting layer covering the first electrode structure 120, and the protecting layer may be an organic material or an inorganic material (such as SiO₂).

FIG. 3 shows that the second electrode structure 130 may be formed of a plane conductive layer. In an embodiment, the second electrode structure 130 may be a plane transparent conductive layer, or formed of a metal material, a metal mesh, or nano metal silts substantially distributed evenly on the substrate 110, wherein the material of the transparent conductive layer may include a metal oxide, an organic conductive material or a combination thereof. Meanwhile, the metal oxide includes indium-tin-oxide, indium-zinc-oxide, zinc oxide, indium oxide, or a combination thereof.

In the embodiment, the first electrode units 122 and the second electrode units 124 of the first electrode structure 120 are independent driving or sensing units, respectively. Therefore, the touch sensing function of the first touch mode may be realized when the first electrode units 122 are sensing electrodes and the second electrode units 124 are driving electrodes or when the first electrode units 122 are driving electrodes and the second electrode units 124 are sensing electrodes. In the meantime, the electrically independent first electrode units 122 and the electrically independent second electrode units 124 may practically perform the touch sensing function. In addition, the second electrode structure 130 may be connected to a ground potential or a common potential in the first touch mode without performing the touch sensing function.

For example, in the embodiment, the first electrode structure 120 includes 6 first electrode units 122 and 8 second electrode units 124, wherein the 6 first electrode units 122 may serve as driving electrodes Y1-Y6; the 8 second electrode units 124 may serve as sensing electrodes X1-X8. When the driving electrodes Y1-Y6 perform scanning in sequence, the touch panel 100 may analyze signals sensed by the sensing electrodes X1-X8 so as to position the point touched by the user. In the first touch mode, the user, for example, directly touches the touch panel 100 to perform operation, and therefore the first touch mode may be regarded as a physical touch mode.

In a second touch mode, the second electrode structure 130 performs the touch sensing function. Specifically, in the second touch mode, the second electrode structure 130 is a driving electrode. Also, the first electrode structure 120 may constitute a plurality of axial sensing electrodes Rx1, Rx2, Rx3, and Rx4 as well as a plane sensing electrode Rx5 via the connection of a driving chip or the switch of a connecting passage. When the second electrode structure 130 performs driving, signals sensed by the axial sensing electrodes Rx1, Rx2, Rx3, and Rx4 as well as the plane sensing electrode Rx5 can position the point touched by the user.

In the second touch mode, an n^{th} first electrode unit 122, an m^{th} first electrode unit 122, an i^{th} second electrode unit 124, and a j^{th} second electrode unit 124 of the first electrode structure 120 are electrically independent from one another to constitute a plurality of axial sensing electrodes Rx1, Rx2, Rx3, and Rx4. In the meantime, the first electrode unit 122 between the n^{th} and the m^{th} first electrode units 122 and the second electrode unit 124 between the i^{th} and the j^{th} second electrode units 124 are electrically connected to each other to constitute a plane sensing electrode Rx5. Here, n, m, i, and j are positive integers greater than zero. However, in other embodiments, it is possible that only the n^{th} and the m^{th} first electrode units 122 are used to constitute the axial sensing electrode; alternatively, it is possible that only the i^{th} and the j^{th} second electrode units 124 are used to constitute the axial sensing electrode. That is to say, in other embodiments, it is possible that only two axial sensing electrodes are present, and the two axial sensing electrodes are located at two opposite sides of the operating area AA.

Specifically, in the embodiment, n, m, i, and j are 1, 6, 1, and 8, respectively. Therefore, the first electrode unit 122 serving as the driving electrode Y1 in the first touch mode serves as the axial sensing electrode Rx1 in the second touch mode. The first electrode unit 122 serving as the driving electrode Y6 in the first touch mode serves as the axial sensing electrode Rx2 in the second touch mode. The first electrode unit 122 serving as the sensing electrode X1 in the first touch mode serves as the axial sensing electrode Rx3 in the second touch mode. The first electrode unit 122 serving as the sensing electrode X8 in the first touch mode serves as the axial sensing electrode Rx4 in the second touch mode. In addition, the first electrode unit 122 serving as the driving electrodes Y2-Y5 as well as the second electrode unit 124 serving as the sensing electrodes X2-X7 in the first touch mode are electrically connected together to be the plane sensing electrode Rx5 in the second touch mode.

However, the invention is not limited thereto. In other embodiments, the touch panel 120 may be designed under the condition that the difference between n and m is greater than 2 and the difference between i and j is greater than 2. Moreover, in the embodiment, an electrode series at the outermost is selected to be the axial sensing electrodes Rx1, Rx2, Rx3, and Rx4. However, in other embodiments, it is possible that two or more electrode series at the outermost are selected to be the axial sensing electrodes Rx1, Rx2, Rx3, and Rx4; that is, each of the axial sensing electrodes Rx1, Rx2, Rx3, and Rx4 may be formed of a plurality of sensing series, respectively.

In the embodiment, the plane sensing electrode Rx5 is formed of a plurality of first electrode units 122 and second electrode units 124 that are closely distributed and electrically connected; therefore, the effective sensing area of the plane sensing electrode Rx5 is larger. Under the circumstances where the user's finger or a stylus does not physically touch the touch panel 100, the plane sensing electrode Rx5 may effectively sense the occurrence of the touch action. Thus, the second touch mode is the hovering touch mode. In other words, the touch panel 100 may provide two touch modes so as to realize the physical touch sensing function and the hovering touch sensing function.

It should be noted that, in the second touch mode, sensing signals of the axial sensing electrodes Rx1, Rx2, Rx3, and Rx4 may be used to determine the user's operation gestures. When the user's operation gesture moves from a side where the axial sensing electrode Rx3 is located to the axial sensing electrode Rx4, the change of the signal of the axial sensing electrode Rx3 that can be acquired from a series of scanning timing gradually decreases, and the change of the axial sensing electrode Rx4 gradually increases. Likewise, the change in the user's operation gesture in the second direction D2 may also be determined via the signal changes of the axial sensing electrode Rx1 and the axial sensing electrode Rx2.

To be precise, the touch panel 100 may provide two touch modes, allowing the user to change the touch mode according to the user's need when in use. For example, the user may choose a suitable touch mode for operation according to the property of the adopted software. Alternatively, the touch panel 100 may perform two touch modes interchangeably instead of performing different touch sensing modes according to the user's option.

Generally speaking, the touch panel 100 may be collocated with the display panel to constitute the touch display apparatus. Accordingly, the following specific examples are provided for describing implementation of the touch display apparatus, which should not be construed as a limitation to the invention.

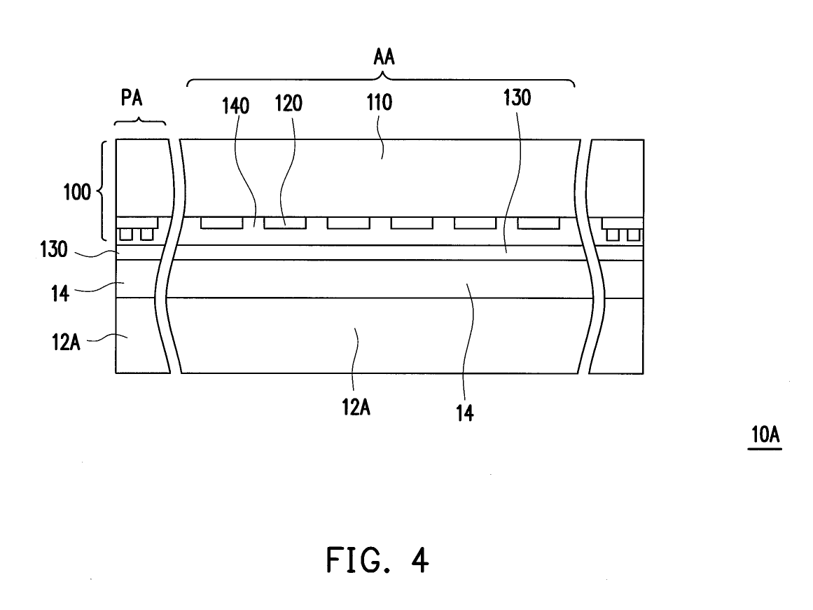

FIG. 4 is a schematic view illustrating a first touch display apparatus having the touch panel in the first embodiment of the invention. Please refer to FIG. 4. A touch display apparatus 10A includes the touch panel 100, a display panel 12A, and an optical adhesive 14 in FIG. 1, wherein the optical adhesive 14 is located between the touch panel 100 and the display panel 12A. In other words, FIG. 4 shows a structure in which the touch panel 100 and the display panel 12A are adhered together via the optical adhesive 14. Here, please refer to the descriptions and figures provided above for introduction of each element of the touch panel 100. The display panel 12A may be a liquid crystal display panel, an electrophoretic display panel, an electro-wetting display panel, an organic light emitting display panel or a combination thereof.

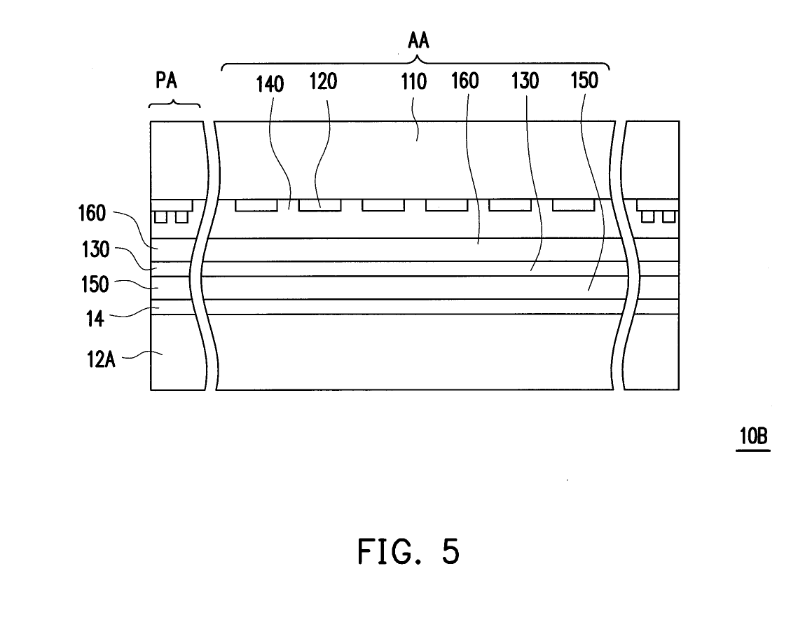

FIG. 5 is a schematic view illustrating a second touch display apparatus having the touch panel in the first embodiment of the invention. Please refer to FIG. 5. A touch display apparatus 10B includes a substrate 110, a first electrode structure 120, a second electrode structure 130, an insulating layer 140, a carrying plate 150, an optical adhesive 160, a display panel 12A, and another optical adhesive 14, wherein the second electrode structure 130 is provided on the carrying plate 150 and the carrying plate 150 is adhered to the substrate 110 via the optical adhesive 160. In addition, the display panel 12A is adhered to the carrying plate 150 via the optical adhesive 14 so that the touch panel having the first electrode structure 120 and the second electrode structure 130 is adhered to the display panel 10A. In the meantime, when not performing the touch sensing function, the second electrode structure 130 may be connected to the ground potential to serve as a shielding electrode layer between a touch signal and a display signal.

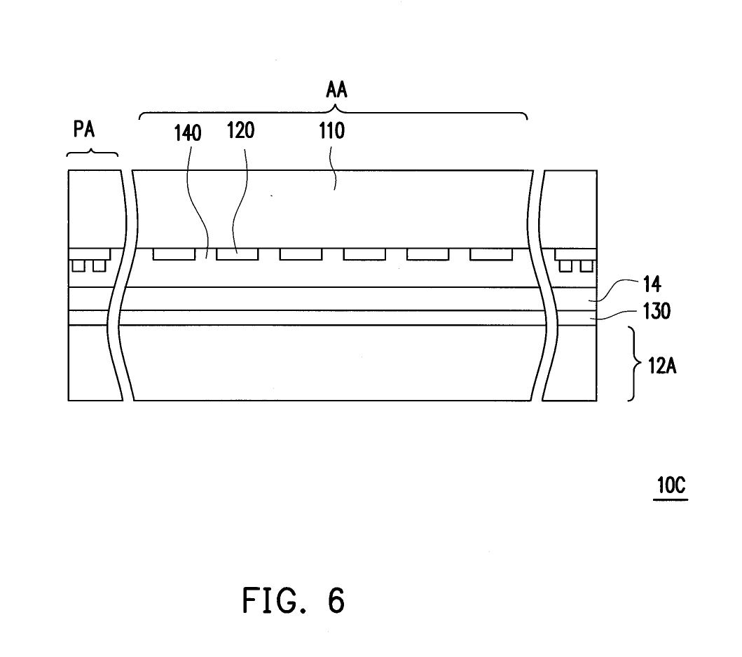

FIG. 6 is a schematic view illustrating a third touch display apparatus having the touch panel in the first embodiment of the invention. Please refer to FIG. 6. A touch display apparatus 10C includes a substrate 110, a first electrode structure 120, a second electrode structure 130, an insulating layer 140, a display panel 12A, and an optical adhesive 14. Here, please refer to FIG. 1 for the design of the substrate 110, the first electrode structure 120 and the insulating layer 140. Specifically, in the embodiment, the second electrode structure 130 is directly provided at a surface of the display panel 12A. Meanwhile, the optical adhesive 14 is adopted to adhere the display panel 12A to the substrate 110 so that the second electrode structure 130 is located between the optical adhesive 14 and the display panel 12A. Accordingly, when not performing the touch sensing function, the second electrode structure 130 may be connected to the ground potential to serve as a shielding electrode layer between the touch signal and the display signal.

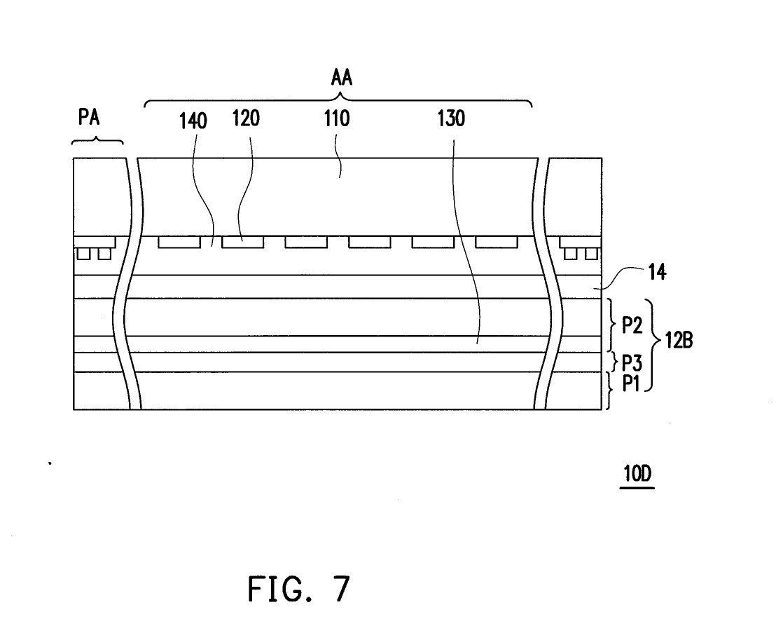

FIG. 7 is a schematic view illustrating a fourth touch display apparatus having the touch panel in the first embodiment of the invention. Please refer to FIG. 7. A touch display apparatus 10D includes a substrate 110, a first electrode structure 120, a second electrode structure 130, an insulating layer 140, a display panel 12B, and an optical adhesive 14. Here, please refer to FIG. 1 for the design of the substrate 110, the first electrode structure 120 and the insulating layer 140. Specifically, in the embodiment, the display panel 12B includes an active device array substrate P1, an opposite substrate P2, and a display medium P3, wherein the display medium P3 is located between the active device array substrate P1 and the opposite substrate P2. In addition, the second electrode structure 130 is disposed within the opposite substrate P2 and located at a side of the opposite substrate P2 adjacent to the display medium P3, wherein the opposite substrate P2 may be a color filter substrate; the display medium P3 may be, for example, liquid crystal.

Here, the second electrode structure 130 may serve as the driving electrode for the hovering touch mode, and the second electrode structure 130 may also serve as an opposite electrode required for driving the display medium P3. Therefore, the second electrode structure 130 may input a driving voltage in the second touch mode (hovering touch mode) and may be inputted with a common voltage in the display mode.

### Second Embodiment

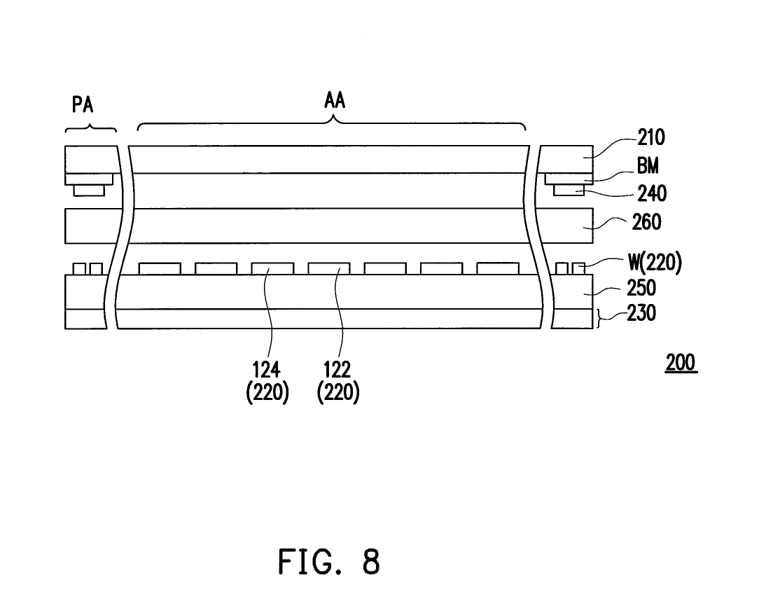

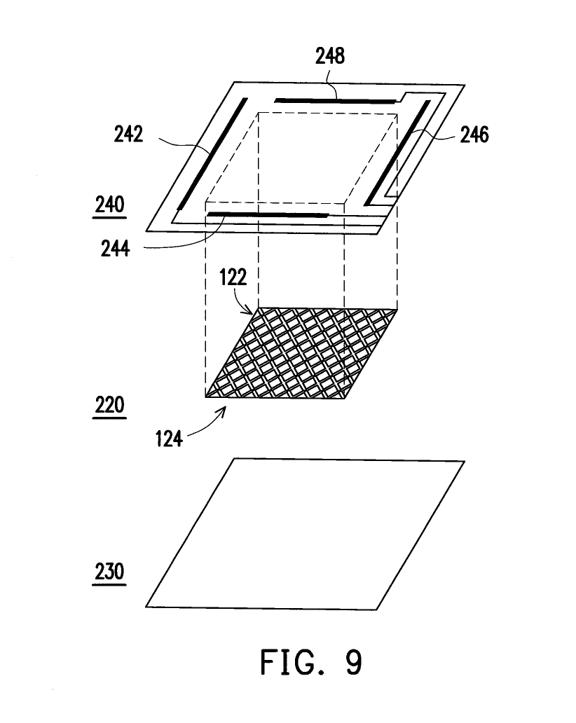

FIG. 8 is a cross-sectional view illustrating a touch panel in a second embodiment of the invention. FIG. 9 is a schematic view illustrating a first electrode structure, a second electrode structure, and a third electrode structure in the touch panel in FIG. 8. Please refer to both FIGS. 8 and 9. A touch panel 200 includes a substrate 210, a first electrode structure 220, a second electrode structure 230, a third electrode structure 240, an insulating layer 250, and an optical adhesive 260. In practical applications, the touch panel 200 may be disposed on the top of the display panel to constitute the touch display apparatus. Generally speaking, a periphery area PA of the substrate 210 is provided with a decoration layer BM and the third electrode structure 240, wherein the decoration layer BM is located between the third electrode structure 240 and the substrate 110 so as to shield the third electrode structures 240.

The first electrode structure 220 is located within the operating area AA. Specifically, the structural design of the first electrode structure 220 is similar to the previous embodiment, i.e. including a plurality of first electrode units 122 and a plurality of second electrode units 124 as shown in FIG. 2. The second electrode structure 230 is distributed evenly in the operating area AA, and the first electrode structure 220 is disposed between the second electrode structure 230 and the substrate 210. Besides, the first electrode structure 220 may include a plurality of wirings W, and the wirings W are disposed within the periphery area PA.

The insulating layer 250 in the embodiment is, for example, a carrying plate, and the first electrode structure 220 and the second electrode structure 230 are respectively provided at two opposite sides of the insulating layer 250. That is to say, the insulating layer 250 is a plate or a film instead of a layer structure. In addition, the first electrode structure 220 and the second electrode structure 230 may be provided on the carrying plate serving as the insulating layer 250, and an optical adhesive 260 may be adopted for adhering the carrying plate serving as the insulating layer 250 to the substrate 210. In the embodiment, the carrying plate serving as the insulating layer 250 and the second electrode structure 230 may be regarded as a part of the display unit, and the carrying plate may be, for example, a color filter substrate; the second electrode structure 230 may be, for example, a Vcom electrode. The touch and display functions may be performed by the operation of the second electrode structure 230 by means of time division multiplexing. Moreover, under this construction, it is also optional for the first electrode structure 220 to form on another surface of the carrying plate serving as the insulating layer 250 such that an electrical isolation between the first electrode structure 220 from the second electrode structure 230, thereby mutually forming an embedded touch display structure.

FIG. 9 shows that a third electrode structure 240 includes a plurality of axial sensing electrodes 242, 244, 246, and 248 surrounding the periphery of the operating area AA, and the third sensing layer 240 is located between the first electrode structure 220 and the substrate 210, please refer to the descriptions concerning the axial sensing electrodes Rx1-Rx4 in the first embodiment for introduction for the operation method thereof. However, in other embodiments, the third sensing layer 240 may have the axial sensing electrodes 242 and 246 only, or may have the axial sensing electrodes 244 and 248 only. That is to say, in other embodiments, it is possible that only two axial sensing electrodes are present, and the two axial sensing electrodes are located at two opposite sides of the operating area AA.

Specifically, the touch panel 200 and the touch panel 100 may equally provide two touch modes. In the first touch mode, the second electrode structure 230 and the third electrode structure 240 do not perform the touch sensing function; the first electrode unit 122 and the second electrode unit 124 of the first electrode structure 220 are electrically independent, respectively, and perform the touch sensing function. In the first touch mode, the user, for example, directly touches the touch panel 100 to perform operation, and therefore the first touch mode may be regarded as a physical touch mode.

In addition, in the second touch mode, the first electrode structure 220, the second electrode structure 230, and the third electrode structure 240 all perform the touch sensing function. Particularly, the first electrode unit 122 and the second electrode unit 124 of the first electrode structure 220 are electrically connected to each other in the second touch mode to constitute a plane sensing electrode. The plane sensing electrode formed by the connected first electrode structure 220 has a greater effective sensing area. Therefore, in the case where the user's finger or stylus does not physically touch the touch panel 200, the plane sensing electrode may effectively sense the occurrence of the touch operation. Accordingly, the second touch mode is the hovering touch mode. In other words, the touch panel 200 may provide two touch modes to realize the physical touch sensing function and the hovering touch sensing function.

Furthermore, in another touch mode operation, the first electrode structure 220 performs the physical touch sensing function; the second electrode structure 230 does not perform the touch sensing function and provides an electrical shelter function only; the third electrode structure 240 performs the hovering touch sensing function. In other words, the touch panel 200 may perform the physical touch sensing function and hovering touch sensing function at the same time.

To be specific, the touch panel 200 may provide two touch modes, and therefore the user may change the touch modes depending on the user's need when in use. For example, the user may choose a suitable touch mode for operation according to the property of the adopted software; alternatively, the touch panel 200 may perform two touch modes interchangeably instead of being limited to the user's option for performing different touch sensing modes.

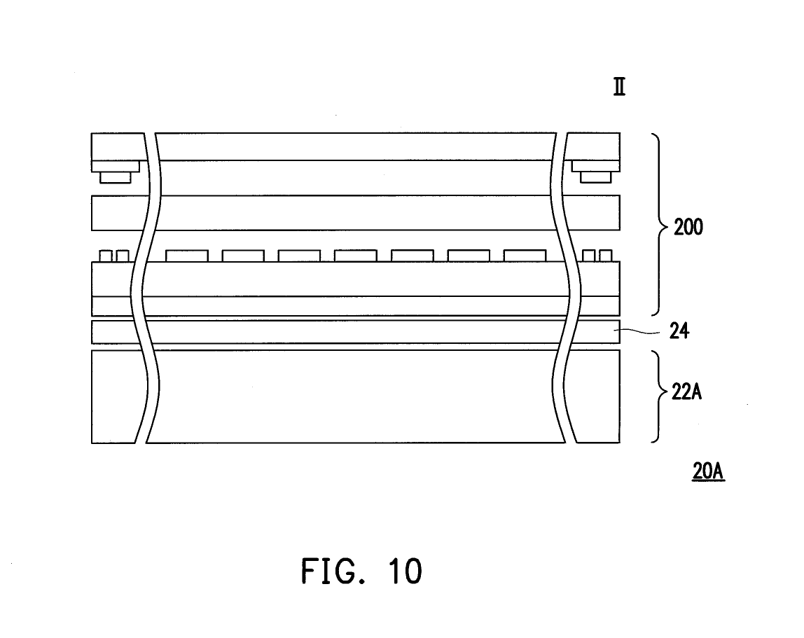

FIG. 10 is a schematic view illustrating a first touch display apparatus having the touch panel in the second embodiment of the invention. Please refer to FIG. 10. A touch display apparatus 20A includes a touch panel 200, a display panel 22A, and another optical adhesive 24 in FIG. 10, wherein the optical adhesive 24 is located between the touch panel 200 and the display panel 22A. In other words, FIG. 10 shows a structure in which the touch panel 200 and the display panel 22A are adhered together via the optical adhesive 24. Here, please refer to the descriptions and figures provided above for introduction of each element of the touch panel 200. The display panel 22A may be a liquid crystal display panel, an electrophoretic display panel, an electro-wetting display panel, an organic light emitting display panel or a combination thereof. It should be noted that, when not performing the touch sensing function, the second electrode structure 230 may be connected to the ground potential to serve as the shielding electrode layer between the touch signal and the display signal.

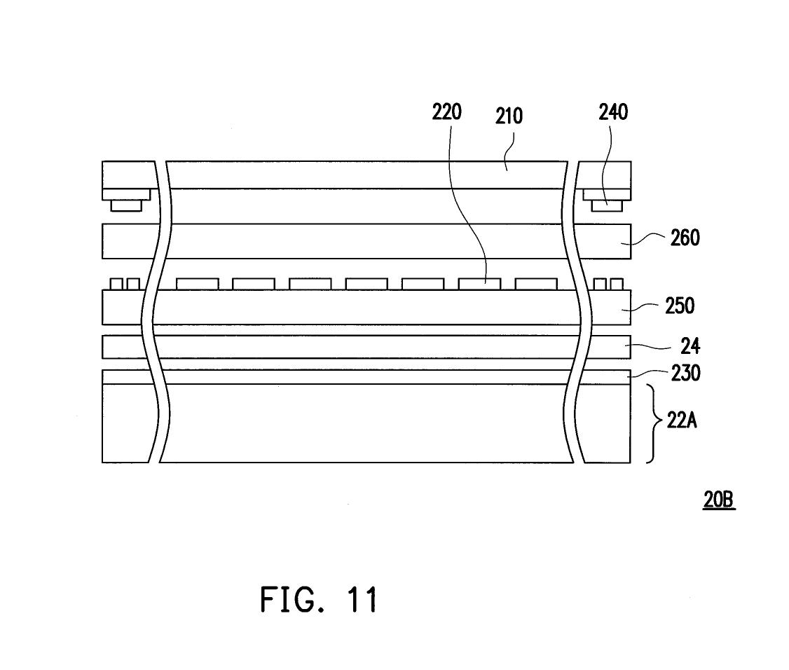

FIG. 11 is a schematic view illustrating a second touch display apparatus having the touch panel in the second embodiment of the invention. Please refer to FIG. 11. A touch display apparatus 20B includes a substrate 210, a first electrode structure 220, a second electrode structure 230, a third electrode structure 240, an insulating layer 250, an optical adhesive 260, a display panel 22A, and another optical adhesive 24. Here, please refer to FIG. 8 for the design of the substrate 210, the first electrode structure 220, the third electrode structure 240, the insulating layer 250, the optical adhesive 260, the display panel 22A, and another optical adhesive 24. Specifically, in the embodiment, the second electrode structure 230 is directly provided on the surface of the display panel 22A. Meanwhile, the optical adhesive 24 adheres the display panel 22A to the carrying plate serving as the insulating layer 250 so that the second electrode structure 230 is located between the optical adhesive 24 and the display panel 22A. Accordingly, when not performing the touch sensing function, the second electrode structure 230 may be connected to the ground potential to serve as the shielding electrode layer between the touch signal and the display signal.

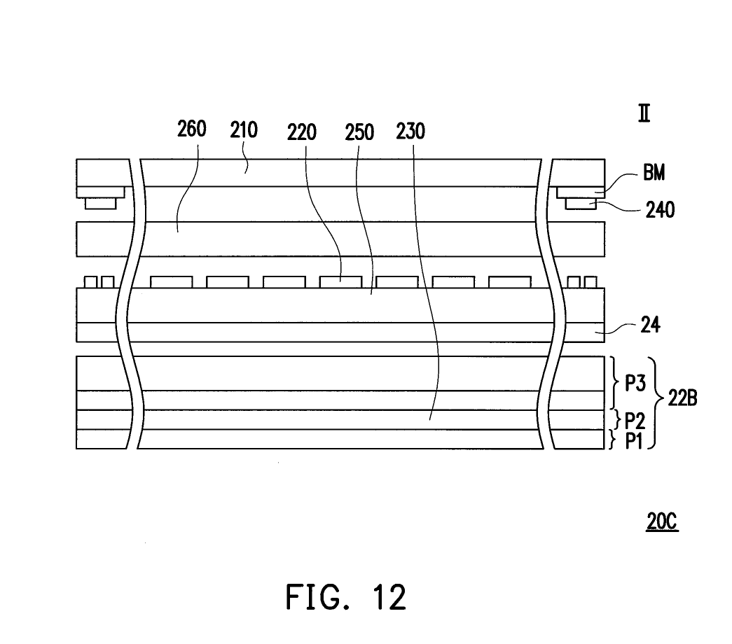

FIG. 12 is a schematic view illustrating a third touch display apparatus having the touch panel in the second embodiment of the invention. Please refer to FIG. 12. A touch display apparatus 20C includes a substrate 210, a first electrode structure 220, a second electrode structure 230, a third electrode structure 240, an insulating layer 250, an optical adhesive 260, a display panel 22B, and another optical adhesive 24. Here, please refer to FIG. 8 for the design of the substrate 210, the first electrode structure 220, the third electrode structure 240, the insulating layer 250, and the optical adhesive 260. The optical adhesive 24 adheres the display panel 22B to the insulating layer 250.

Specifically, in the embodiment, the display panel 22B includes an active device array substrate P1, an opposite substrate P2, and a display medium P3, wherein the display medium P3 is located between the active device array substrate P1 and the opposite substrate P2. Besides, the second electrode structure 230 is disposed within the opposite substrate P2 and located at one side of the opposite substrate P2 adjacent to the display medium P3. Here, the second electrode structure 230 may server as the driving electrode for the hovering touch mode, and may also serve as an opposite electrode required for driving the display medium P3. Accordingly, the second electrode structure 230 may be inputted with a scan voltage in the second touch mode (hovering touch mode) and may be inputted with a common voltage in the display mode.

### Third Embodiment

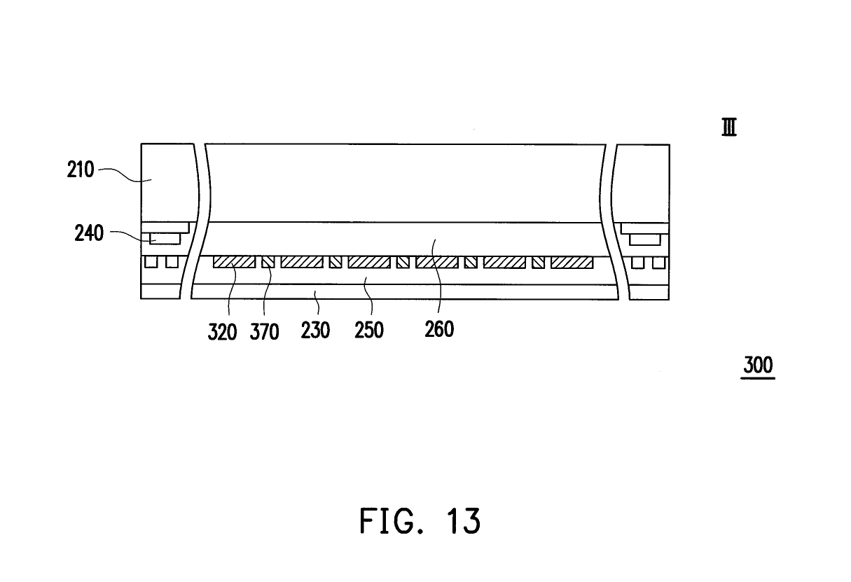

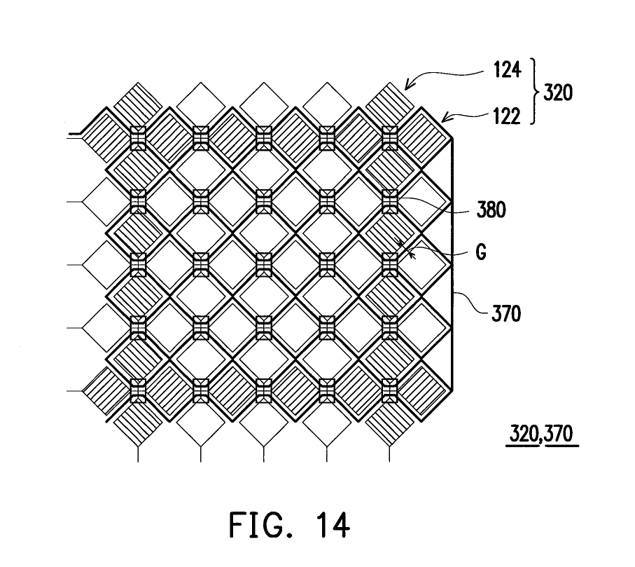

FIG. 13 is a cross-sectional view illustrating a touch panel in a third embodiment of the invention. FIG. 14 is a top view illustrating a first sensing electrode layer and a second sensing electrode layer in the touch panel in FIG. 13. Please refer to both FIGS. 13 and 14. The touch panel 300 is similar to the touch panel 200. Therefore, the same elements in the two embodiments are denoted by the same reference numbers without further description. Specifically, the embodiment is different from the previous embodiment in that the touch operation of the first electrode structure 320 and the touch panel 300 further includes a fourth electrode structure 370.

FIG. 14 shows that the first electrode structure 320 includes a plurality of first electrode units 122 and a plurality of second electrode units 124 as the previous embodiment, and the first electrode units 122 as well as the second electrode units 124 are composed of electrode series, respectively. Please refer to the description in the first embodiment for the specific structure and introduction of the first electrode structure 320. Furthermore, the fourth electrode structure 370 is distributed within the operating area along a gap G between the first electrode units 122 and the second electrode units 124. In the meantime, the touch panel 300 further includes a plurality of insulating structures 380 disposed at a position where the fourth electrode structure 370, the first electrode unit 122s, and the second electrode units 124 interlace with one another.

In terms of the touch mode, the touch panel 300 may equally perform at least two touch modes. In the first touch mode, only the first electrode structure 320 performs the touch sensing function; the second electrode structure 230, the third electrode structure 240, and the fourth electrode structure 370 do not perform the touch sensing function. In the mode, the first electrode units 122 and the second electrode units 124 are electrically independent from each other. The first electrode units 122 are driving electrodes and the second electrode units 124 are sensing electrodes. Alternatively, the first electrode units 122 are sensing electrodes and the second electrode units 124 are driving electrodes

In the second touch mode, the second electrode structure 230, the third electrode structure 240, and the fourth electrode structure 370 all perform the touch sensing function; only the first electrode structure 320 does not perform the touch sensing function. The third electrode structure 240 may include a plurality of axial sensing electrodes as the second embodiment. The fourth electrode structure 370 is substantially distributed evenly on the substrate 210 to constitute a plane sensing electrode in the second touch mode. Please refer to the second embodiment for description of the specific operation method of the second touch mode. In the embodiment, the first electrode structure 320 performs the touch sensing function only in the first touch mode, and is not partially electrically connected together by a driving circuit, which helps to reduce the burden on a driving chip.

Moreover, the touch panel 300 may be integrated with the display panel 22A or 22B to constitute a touch display apparatus by referring to the structural design in FIGS. 10-12. The specific structure is already described as above and no further description is provided herein. Also, the above embodiments provide no limitation to the structural design of the touch panel.

### Fourth Embodiment

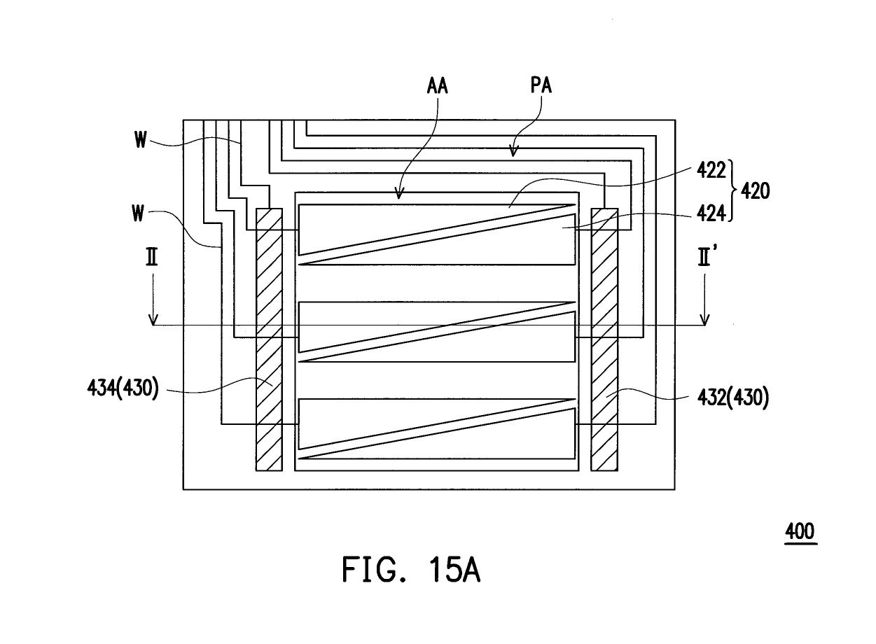

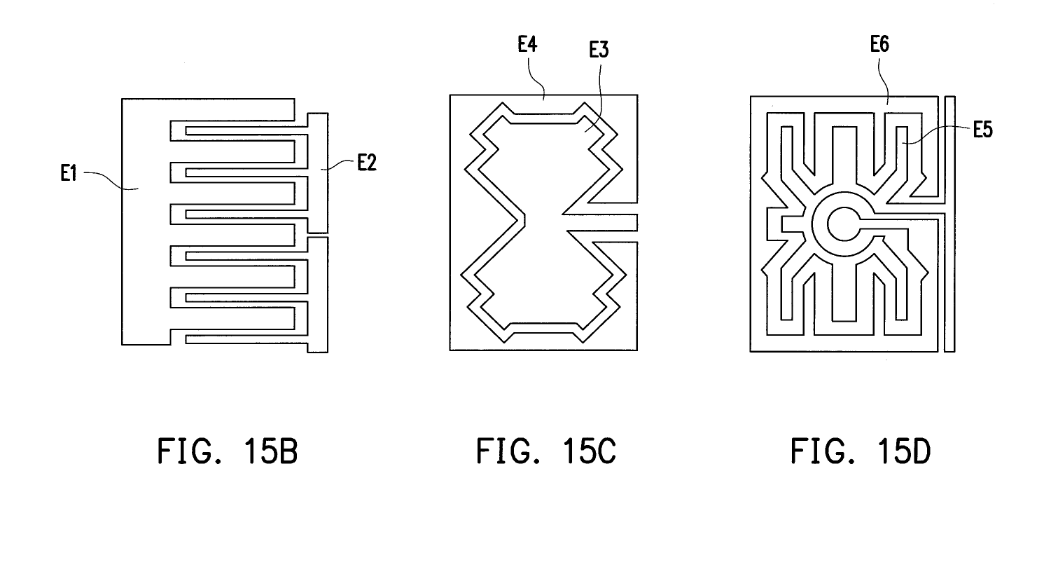

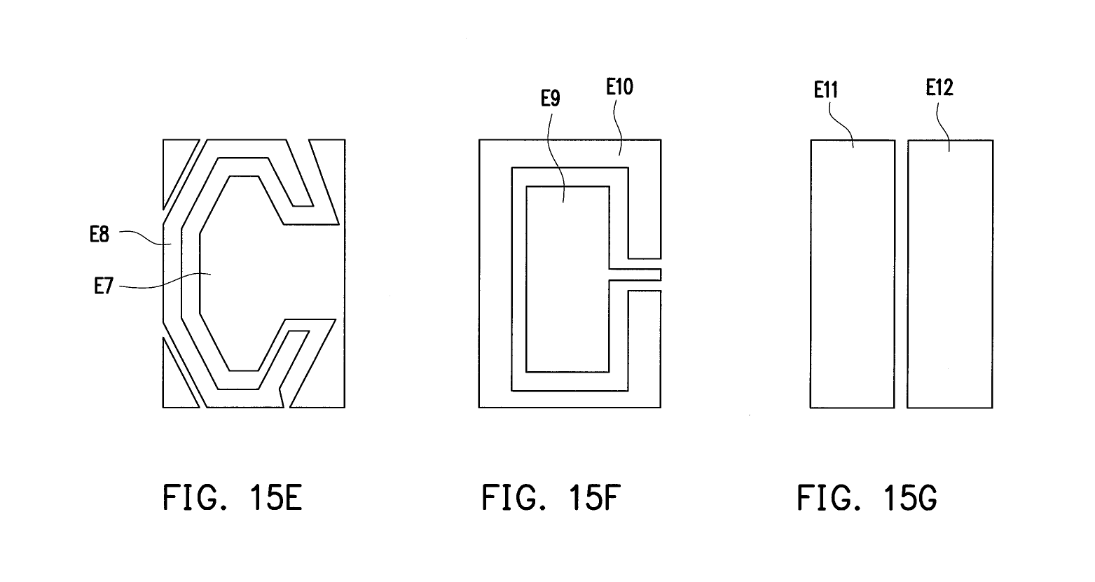

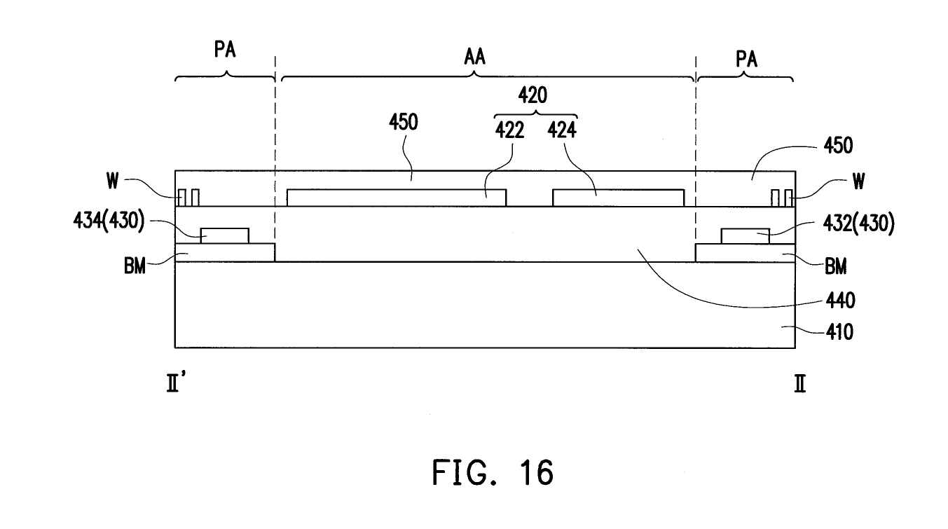

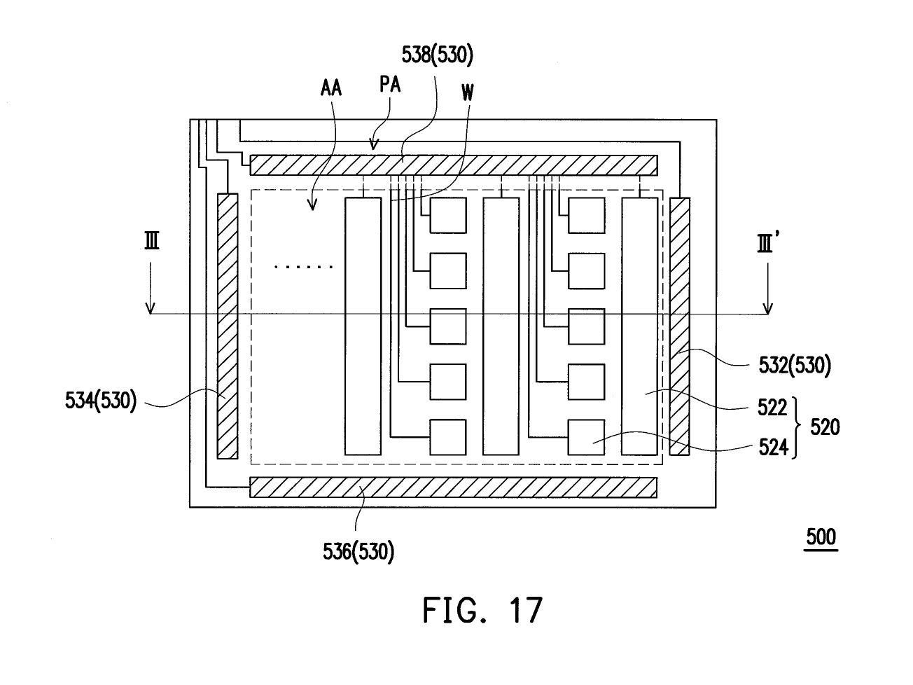

To be specific, FIG. 15A is a bottom view illustrating a touch panel in a fourth embodiment of the invention. FIG. 16 is a cross-sectional view of the touch panel in FIG. 15A along line II-II′. Please refer to both FIGS. 15A and 16. A touch panel 400 includes a substrate 410, a first electrode structure 420, a second electrode structure 430, an insulating layer 440, a decoration layer BM, and a protecting layer 450. The substrate 410 has an operating area AA and a periphery area PA surrounding the operating area AA. The decoration layer BM is disposed within the periphery area AA and surrounds the operating area AA. The first electrode structure 420 is at least disposed within the operating area AA. The second electrode structure 430 is disposed between the first electrode structure 420 and the substrate 410, and includes a plurality of axial sensing electrodes or a plurality of additional sensing electrodes. The embodiment is exemplified using the second electrode structure 430 as a plurality of axial sensing electrodes, wherein the second electrode structure 430 includes a first axial sensing electrode 432 and a second axial sensing electrode 434. In other embodiments, the second electrode structure 430 forms a plurality of additional sensing electrodes. The additional sensing electrodes mainly serve as a proximity detector (such as detecting face, hand, or other conductors with a large area) or an import function key and so on. The principle of detection may be self-capacitance or mutual-capacitance measuring principle. The insulating layer 440 is disposed between the first electrode structure 420 and the second electrode structure 430. The protecting layer 450 covers the first electrode structure 420, and the first electrode structure 420 as well as the second electrode structure 430 are disposed between the substrate 410 and the protecting layer 450.

When the second electrode structure 430 is a plurality of additional sensing electrodes, a pattern of the additional sensing electrodes may be two sensing electrodes embedded with each other, and the additional sensing electrodes may be disposed at any position on the decoration layer BM (marked in FIG. 16) depending on the requirement with no limitation to the numbers and the pattern. As shown in FIGS. 15B to 15G, in FIG. 15B, a finger-shaped electrode E1 and a finger-shaped electrode E2 are embedded with each other to form a design of the additional sensing electrodes. In FIG. 15C, an electrode E3 has a dumbbell-shaped outline, and an electrode E4 substantially surrounds the electrode E3 and may constitute another design of the additional sensing electrodes. In addition, electrodes E5 and E6 in FIG. 15D, electrodes E7 and E8 in FIG. 15E, and electrodes E9 and E10 in FIG. 15F are also designed to be embedded with each other, which serve as various cadence patterns for the additional sensing electrodes. In FIG. 15G, electrodes E11 and E12 are designed to be parallel, which may also serve as another cadence pattern for the additional sensing electrodes.

In the embodiment, although the first electrode structure 420 is disposed on the insulating layer 440, in other embodiments that are not shown, the first electrode structure 420 may be at least disposed on another substrate (not shown). The substrate 410 (marked in FIG. 16) and said another substrate are fixed to each other via an insulating adhesive, and the thickness of the adhesive is between 100 and 250 μm. Said another substrate may be a color filter substrate, a thin film substrate, an upper cover on a display panel or a lower substrate of a display panel. The first electrode structure 420 may be disposed within another substrate near or distant from any side of the second electrode structure 430.

In the embodiment, although the second electrode structure 430 is disposed on the decoration layer BM only, in other embodiments that are not shown, the second electrode structure 430 may be respectively disposed on the operating area AA and the decoration layer BM of the substrate 410, thereby providing another structural design for the touch panel. For example, in the mutual-capacitance touch principle, the second electrode structure disposed in the operating area AA of the substrate 410 may serve as a touch sensing electrode of the operating area AA; the second electrode structure disposed on the decoration layer BM may serve as the aforementioned additional sensing electrodes. Additionally, the first electrode structure (not shown) disposed on another substrate (not shown) may serve as a touch driving electrode of the operating area AA.

In the embodiment, the insulating layer 440 is disposed between the first electrode structure 420 and the second electrode structure 430 to electrically insulate the first electrode structure 420 from the second electrode structure 430. The second electrode structure 430 includes a plurality of axial sensing electrodes. Accordingly, the touch panel 400 may perform two touch modes. In a first touch mode, the second electrode structure 430 does not perform the touch sensing function, and the first electrode structure 420 performs the touch sensing function. In a second touch mode, the second electrode structure 430 performs the touch sensing function, and the first electrode structure 420 does not perform the touch sensing function. In the embodiment, the first touch mode may be the physical touch sensing mode, and the second touch mode may be the hovering touch sensing mode.

In the embodiment, the first electrode structure 420 includes a plurality of first electrode units 422 and a plurality of second electrode units 424, and each of the first electrode units 422 is disposed next to one of the second electrode units 424. The touch panel 400 is provided with a plurality of wirings W disposed therein, wherein one of the wirings W is connected to one of the first electrode units 422 and the second electrode units 424 to transmit signals of the first electrode units 422 and the second electrode units 424. A portion of the wirings W may overlap with a portion of the axial sensing electrode or the additional sensing electrodes so as to meet the requirement for a maximized effective display area while the non-display area (such as the periphery area PA) has the sensing electrode as shown in FIG. 15A. A shielding layer (not shown) may be optionally disposed between the first electrode structure 420 and the second electrode structure 430 so as to shield mutual interference between first electrode structure 420 and the second electrode structure 430. Nevertheless, the wirings W may not overlap with the axial sensing electrode or the additional sensing electrodes so as to avoid mutual interference between the first electrode structure 420 and the second electrode structure 430.

In the first touch mode, the operation method of the touch panel 400 is to make the first electrode units 422 to be driving electrodes and the second electrode units 424 to be sensing electrodes to perform the touch sensing function; alternatively, it may be that the first electrode units 422 are sensing electrodes and the second electrode units 424 are driving electrodes to perform the touch sensing function. Moreover, the first electrode units 422 and the second electrode units 424 may be composed of the same electrode layer; that is, the first electrode structure 420 is a single-layered electrode structure. Therefore, each element of the first electrode structure 420 does not interlace with one another.

In addition, in the embodiment, the second electrode structure 430 includes a first axial sensing electrode 432 and a second axial sensing electrode 434, wherein each one of the first axial sensing electrode 432 and the second axial sensing electrode 434 is connected to a wiring W. The first axial sensing electrode 432 and the second axial sensing electrode 434 are located at two opposite sides of the operating area AA. Meanwhile, the first axial sensing electrode 432 and the second axial sensing electrode 434 are respectively composed of a stripe conductive pattern. In the second touch mode, the first axial sensing electrode 432 and the second axial sensing electrode 434 perform the touch sensing function so as to read the sensed signal value.

When the user's finger or the stylus gets close to the touch panel 400 without directly touching the touch panel 400, the first axial sensing electrode 432 and the second axial sensing electrode 434 can sense a coupling signal stimulated by the finger or the stylus. When the user's finger or the stylus waves, a distance between the finger or the stylus relative to the first axial sensing electrode 432 changes. Moreover, a distance from the finger or the stylus relative to the second axial sensing electrode 434 changes as well. The touch panel 400 may calculate the user's waving trajectory according to the variation of the coupling signal. That is to say, the second touch mode is a hovering touch mode. In the embodiment, the first touch mode is independent from the second touch mode, and therefore the two touch modes may be performed at different times. Besides, the signals of the two touch modes do not interfere with each other.

In addition, in the embodiment, the first axial sensing electrode 432 and the second axial sensing electrode 434 are disposed within the periphery area PA and disposed on the decoration layer BM. Accordingly, there is no need to limit the light-penetrability of the first axial sensing electrode 432 and the second axial sensing electrode 434, which may be manufactured with a light-impenetrable conductive material. However, the first electrode structure 420 is disposed within the operating area AA. When the touch panel 400 is required to have light-penetrable properties, the first electrode units 422 and the second electrode units 424 of the first electrode structure 420 need to have light-penetrable properties, and the material thereof may be a transparent conductive material or a metal mesh, nano metal silts and so on that is hardly visible to human's eyes.

The first electrode structure 420 and the second electrode structure 430 are recited as examples only and should not be construed as a limitation to the invention.

### Fifth Embodiment

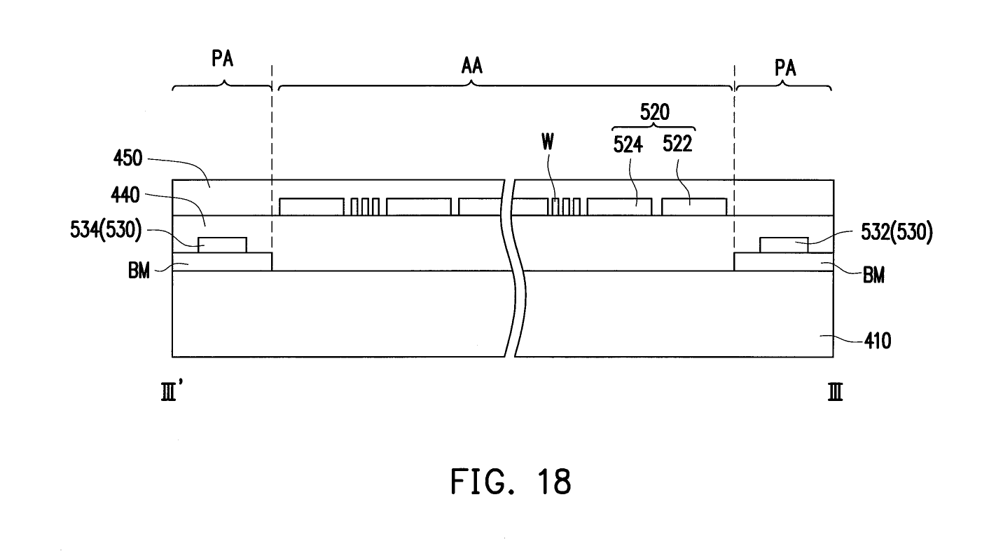

For example, FIG. 17 is a bottom view illustrating a touch panel in a fifth embodiment of the invention. FIG. 18 is a cross-sectional view illustrating the touch panel in FIG. 17 along line III-III′. Please refer to both FIGS. 17 and 18. A touch panel 500 includes a substrate 410, a first electrode structure 520, a second electrode structure 530, an insulating layer 440, a protecting layer 450, and a decoration layer BM. Here, the substrate 410, the insulating layer 440, the protecting layer 450, and the decoration layer BM are the same as in the previous embodiments; therefore, no further descriptions are provided herein.

Specifically, in the embodiment, the first electrode structure 520 includes a plurality of first electrode units 522 and a plurality of second electrode units 524, wherein the first electrode units 522 are stripe electrode patterns, respectively. A number of second electrode units 524 are located beside one of the first electrode units 522. The first electrode units 522 and the second electrode units 524 have a wiring W, respectively. FIG. 17 only shows a portion of the wirings W selectively. In actual designs, an extending direction of the wirings W may change according to the design for different apparatuses.

Furthermore, in the first electrode structure 520, the stripe first electrode units 522 may be driving electrodes and the second electrode units 524 may be sensing electrodes. In the first touch mode, the first electrode units 522 and the second electrode units 524 may be used to sense the sensing signal generated when the user physically touches the touch panel 500. That is to say, the first electrode structure 520 may perform the physical touch sensing mode.

In the embodiment, the second electrode structure 530 includes a first axial sensing electrode 532, a second axial sensing electrode 534, a third axial sensing electrode 536, and a third axial sensing electrode 538. All the axial sensing electrodes 532, 534, 536, and 538 are located within the periphery area PA outside the operating area AA. The first axial sensing 532 and the second axial sensing electrode 534 are respectively located at two opposite sides of the operating area AA; the third axial sensing electrode 536 and the fourth axial sensing electrode 538 are respectively located at another two opposite sides of the operating area AA. In other words, the first axial sensing electrode 532, the second axial sensing electrode 534, the third axial sensing electrode 536, and the fourth axial sensing electrode 538 surround the operating area AA.

In the embodiment, when the user's finger or the stylus gets close to the touch panel 500 without directly touching the touch panel 500, the first axial sensing electrode 532, the second axial sensing electrode 534, the third axial sensing electrode 536, and the fourth axial sensing electrode 538 can sense the coupling signal stimulated by the finger or the stylus. When the user's finger or the stylus waves, the distance from the finger or the stylus relative to the first axial sensing electrode 532, the second axial sensing electrode 534, the third axial sensing electrode 536, and the fourth axial sensing electrode 538 changes. That is to say, the touch panel 500 may perform a second touch mode which is a hovering touch mode. In the embodiment, the first touch mode and the second touch mode may be performed at different times.

Additionally, the size of one of the first axial sensing electrode 532 and the second axial sensing electrode 534 may be different from the size of one of the third axial sensing electrode 536 and the fourth axial sensing electrode 538. Therefore, the sensing amount of the first axial sensing electrode 532 and the second axial sensing electrode 534 will be different from the sensing amount of the third axial sensing electrode 536 and the fourth axial sensing electrode 538. The touch panel 500 may determine the trajectory that moves according to the difference in the sensing amount when the user performs the touching function.

It should be noted that, in the embodiment, the design for the four axial sensing electrodes may be applied in the touch panel 400 in FIG. 15A; alternatively, the first electrode units 522 and the second electrode units 524 in the embodiment may be applied in the touch panel 400 in FIG. 15A. Accordingly, the specific structure of the first electrode structure and the second electrode structure in the touch panel may be determined according to different design requirements. In addition, FIGS. 15A and 17 both show that the first electrode structure is a single-layered electrode structure, which should not be construed as a limitation to the invention. In other embodiments, the first electrode structure disposed in the operating area AA may have a pattern design as shown in FIG. 2. That is to say, the first electrode structure 120 in FIG. 2 may substitute for the first electrode structures 420 and 520 in FIGS. 15A and 17. Meanwhile, each of the first electrode units and each of the second electrode units may be an electrode series, and the electrode series includes a plurality of electrode patterns and connecting patterns that connect the electrode patterns in series. The electrode patterns and connecting patterns in at least one sensing series have the same material. The electrode patterns and connecting patterns in at least one sensing series have the different material. Specifically, the previous embodiments show that, when the second touch mode, i.e. the hovering touch mode, is performed, the electrode structure that is entirely and evenly distributed in the operating area AA as a driving electrode may be selectively omitted.

In summary, the invention may provide a touch panel and a display apparatus thereof which have a touch sensing function in both non-display area and display area and meet the requirement for a maximized effective display area. In addition, the touch panel and the touch display apparatus in the embodiments of the invention may provide at least two touch modes, wherein one is a physical touch mode and the other one is a hovering touch mode. Accordingly, the application of the touch panel and the touch display apparatus in the embodiments of the invention may be more versatile and meet contemporary demands.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. A touch panel, comprising:
a substrate, having an operating area;
a first electrode structure, located within the operating area, comprising a plurality of first electrode units and a plurality of second electrode units, each of the first electrode units extending in a first direction, each of the second electrode units extending in a second direction, and the first electrode units and the second electrode units interlacing with each other;
a second electrode structure, evenly distributed within the operating area, and the first electrode structure being disposed between the second electrode structure and the substrate, wherein in a first touch mode, the second electrode structure does not perform a touch sensing function and the first electrode units and the second electrode units are electrically independent, respectively and perform the touch sensing function; in a second touch mode, the second electrode structure performs the touch sensing function; and
an insulating layer, disposed between the first electrode structure and the second electrode structure to electrically insulate the first electrode structure from the second electrode structure.

2. The touch panel according to claim 1, wherein an n^{th} first electrode unit, an m^{th} first electrode unit, an i^{th} second electrode unit, and a j^{th} second electrode unit of the first electrode structure are electrically independent from one another in the second touch mode to constitute a plurality of axial sensing electrodes, and the first electrode units between the n^{th} and the m^{th} first electrode units as well as the second electrode units between the i^{th} and the j^{th} second electrode units are electrically connected together in the second touch mode to constitute a plane sensing electrode, in which n, m, i, j are positive integers greater than zero, a difference between n and m is greater than 2, and a difference between i and j is greater than 2.

3. The touch panel according to claim 1, wherein the second electrode structure is a driving electrode in the second touch mode.

4. The touch panel according to claim 1, wherein the second electrode structure is connected to a ground potential or a common potential in the first touch mode.

5. The touch panel according to claim 1, further comprising a third electrode structure disposed on the substrate, the third electrode structure being located between the first electrode structure and the substrate, and the third electrode structure comprising a plurality of axial sensing electrodes surrounding a periphery of the operating area.

6. The touch panel according to claim 5, wherein the third electrode structure performs the touch sensing function in the second touch mode, and the first electrode units and the second electrode units of the first electrode structure are electrically connected together in the second touch mode to constitute a plane sensing electrode.

7. The touch panel according to claim 5, further comprising a fourth electrode structure, distributed within the operating area along a gap between the first electrode units and the second electrode units to constitute a plane sensing electrode in the second touch mode.

8. The touch panel according to claim 7, further comprising a plurality of insulating structures disposed at a position where the fourth electrode structure, the first electrode units, and the second electrode units interlace with one another.

9. The touch panel according to claim 1, wherein the second electrode structure is disposed on a carrier layer, and the carrier layer is adhered to the substrate via an optical adhesive.

10. The touch panel according to claim 9, wherein the second electrode structure is located between the carrier layer and the optical adhesive.

11. The touch panel according to claim 1, wherein the first electrode structure is configured on a carrier layer adhered to the substrate via an optical adhesive so that the first electrode structure is located between the carrier layer and the substrate.

12. The touch panel according to claim 1, wherein, in the first touch mode, the first electrode units are sensing electrodes and the second electrode units are driving electrodes; alternatively, the first electrode units are driving electrodes and the second electrode units are sensing electrodes.

13. The touch panel according to claim 1, wherein each of the first electrode units and the second electrode units is an electrode series, and the electrode series comprises a plurality of electrode patterns and connecting patterns connecting the electrode patterns in series.

14. The touch panel according to claim 13, wherein the electrode patterns and the connecting patterns in at least one electrode series have the same material or different material.

15. A touch panel, comprising:
a substrate, having an operating area;
a first electrode structure, located within the operating area;
a second electrode structure, disposed between the first electrode structure and the substrate and comprising a plurality of axial sensing electrodes, wherein the second electrode structure does not perform a touch sensing function while the first electrode structure performs the touch sensing function in the first touch mode, and the second electrode structure performs the touch sensing function while the first electrode structure does not perform the touch sensing function in a second touch mode; and
an insulating layer, disposed between the first electrode structure and the second electrode structure to electrically insulate the first electrode structure from the second electrode structure.

16. The touch panel according to claim 15, wherein the axial sensing electrodes of the second electrode structure are located within a periphery area outside the operating area, and wherein the axial sensing electrodes of the second electrode structure comprise a first axial sensing electrode and a second axial sensing electrode, and the first axial sensing electrode and the second axial sensing electrode are respectively located at two opposite sides of the operating area.

17. The touch panel according to claim 16, wherein the axial sensing electrodes of the second electrode structure further comprise a third axial sensing electrode and a fourth axial sensing electrode, the first axial sensing electrode, the second axial sensing electrode, the third axial sensing electrode, and the fourth axial sensing electrode surround the operating area, and the third axial sensing electrode and the fourth axial sensing electrode are respectively located at another two opposite sides of the operating area.

18. A touch panel, having a light-penetrable area and a light-shielding area, the light-shielding area being located at at least one side of the light-shielding area, the touch panel comprising:
a first substrate;
a second substrate, disposed substantially in parallel with the first substrate;
a decoration layer, disposed on the second substrate to constitute the light-shielding area;
a first electrode structure, disposed on the first substrate and at least disposed within the light-penetrable area, the first electrode structure comprising a plurality of sensing electrodes and a plurality of wirings, and the wirings and the sensing electrodes being electrically connected; and
a second electrode structure, at least disposed on the decoration layer, the second electrode structure being located between the first electrode structure and the second substrate, the second electrode structure and the first electrode structure being electrically independent from each other, the second electrode structure comprising a plurality of additional sensing electrodes or a plurality of axial sensing electrodes.

19. The touch panel according to claim 18, wherein a portion of the wirings overlaps with a portion of the additional sensing electrode.

20. The touch panel according to claim 19, wherein a shielding layer is disposed between the first electrode structure and the second electrode structure so as to block mutual interference between the first electrode structure and the second electrode structure.
